(19) United States
(12) Patent Application Publication
(10) Pub. No.: US 2005/0216210 A1
(43) Pub. Date: Sep. 29, 2005

(54) Real-time code multipath mitigation in the frequency domain using FDsmooth™ for Global Navigation Satellite Systems

(76) Inventors: Chris Gregory Bartone, Athens, OH (US); Yujie Zhang, Athens, OH (US)

Correspondence Address: Chris Gregory Bartone, P.O. Box 5601, Athens, OH, 45701, US

(21) Appl. No.: 11/087,021

(22) Filed: Mar. 21, 2005

Related U.S. Application Data
(60) Provisional application No. 60/556,068, filed on Mar. 25, 2004.

(51) Int. Cl. G06F 11/30

(52) U.S. Cl. 702/56

(57) ABSTRACT

This FDsmooth™ frequency domain code multipath mitigation technique for real-time application. Firstly, a multipath spectral estimation technique is used to provide multipath frequency spectrum analysis, which was used to bound the frequency domain region for mitigation; either a multipath model or spectral estimation on the GNSS observable data can be accomplished Secondly, a code-minus-carrier (CmC) analysis exposes the major code multipath error and its frequency spectrum, which was the basis for operation; Thirdly, a code multipath correction was formed and applied to mitigate the multipath error in the GNSS code measurement. Both the multipath mitigated code measurement and the carrier phase measurement can be utilized for the user solution, which improves performance. The technique is well suited for ground-based applications where the multipath fading frequency can be well predicted, as well as, for mobile user applications where this multipath frequency can be estimated using a spectral estimation technique.

### CROSS-REFERENCE TO RELATED APPLICATIONS

A provisional patent was submitted by the investors and received by the USPO with application No. 60/556,068, filing date Mar. 25, 2004 and confirmation number 5407, with title “Real-time multipath mitigation in the frequency domain for global navigation satellite systems”. Heading

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF INVENTION

The invention relates generally to multipath mitigation of errors inherent in spread-spectrum signals, and more particularly to a frequency domain-based error mitigation technique directly applicable to Global Navigation Satellite Systems (GNSS) (e.g., GPS, Galileo, GLONASS, etc). This FDsmooth™ multipath mitigation technique can be integrated into GNSS software processing to improve performance. The processing can be implemented in new GNSS or existing receiver configurations. The FDsmooth™ technique can be implemented in real-time or in a post-processing fashion.

GNSS architectures are typically multi-frequency and can be implemented by the user as a single, dual, or multi-frequency fashion to calculate the user state (i.e., position, velocity, and time). Multiple frequencies are used to help with ionosphere error mitigation as well as interference immunity. Multiple codes are implemented to provide different levels of performance/service. Modulation encodes data and codes onto the carrier frequency for transmission from the Space Vehicle (SV) to the mobile user. GNSS measurements may be modeled as the following for the code and carrier phase respectively between the user and a particular SV; the text book by Misra, P. and Enge, P., Global Position System Signals, Measurements, and Performance, Ganga-Jamuna Press, Lincoln, Mass., 2001, pp. 125-128 detail on these signal models used for GPS.
ρ_{q,k}=rₖ+δt^{SV}+bᵤ+I_{q,k}+Tₖ+M_{q,p,k}+ε_{q,p,k}
and
φ_{q,k}=rₖ+δt^{SV}+bᵤ−I_{q,k}+Tₖ+M_{q,φ,k}+ε_{q,φ,k}+N_{q,φ,k} (1)
where:
ρ_{q,k}: pseudorange measurement at frequency q, and time epoch k[m]
rₖ: true range at frequency q, and time epoch k[m]
δt^{SV}: space vehicle clock error [m]
bᵤ: user receiver clock bias error [m]
Iₖ: ionosphere error at frequency q, and at time epoch k[m]
Tₖ: ionosphere error at time epoch k [m]
M_{q,p,k}: code phase multipath error at frequency q, and at time epoch k [m]
ε_{q,p,k}: code phase error at frequency q, and at time epoch k [m]
φ_{q,k}: carrier phase measurement at frequency q, and time epoch k[m]
M_{q,φ,k}: carrier phase multipath error at frequency q, and at time epoch k [m]
ε_{q,φ,k}: carrier phase error at frequency q, and at time epoch k [m]
λq: carrier phase wavelength at frequency q [m]
N_{q,φ,k}: carrier phase ambiguity related bias at frequency q, and at time epoch k [m]
q: GNSS center frequency for signal of interest [Hz]
k: time epoch [unitless]

Multi-frequency GNSS measurements can be used to remove the effects from the ionosphere. Dual-frequency GPS measurements are formed to produce ionosphere free (iono-free) code and carrier phase measurement as Equation (2), in accordance with the textbook by Misra, P. and Enge, P., Global Position System Signals, Measurements, and Performance, Ganga-Jamuna Press, Lincoln, Mass., 2001, pp. 141-142 for GPS.

$${ρ}_{k}^{*} = \frac{{f}_{L1}^{2}}{{f}_{L1}^{2} - {f}_{L2}^{2}} {ρ}_{L1 , k} - \frac{{f}_{L2}^{2}}{{f}_{L1}^{2} - {f}_{L2}^{2}} {ρ}_{L2 , k} and \\ {ϕ}_{k}^{*} = \frac{{f}_{L1}^{2}}{{f}_{L1}^{2} - {f}_{L2}^{2}} {ϕ}_{L1 , k} - \frac{{f}_{L2}^{2}}{{f}_{L1}^{2} - {f}_{L2}^{2}} {ϕ}_{L2 , k} \qquad ( 2 )$$

where
f_{L1}: GPS L1 frequency 1575.42 MHz
f_{L2}: GPS L2 frequency 1227.60 MHz
*: iono-free
ρ: code measurement [m]
φ: carrier phase measurement [m]

Using the code and carrier phase models presented in Equation (1), a Code minus Carrier (CmC) signal can be formed for single-frequency GNSS users in accordance with Equation (3) at every time epoch k, (for each space vehicle (SV)).

$$\begin{matrix}{CmC}_{biased , k} = {ρ}_{q , k} - {ϕ}_{q , k} \\ = 2 {I}_{q , k} - {N}_{ϕ , k} + {M}_{q , ρ , k} - {M}_{q , ϕ , k} + {ɛ}_{q , ρ , k} - {ɛ}_{q , ϕ , k}\end{matrix} \qquad ( 3 )$$

where:
CmC_{biased,k}=biased Code minus Carrier residual at frequency q, and at time epoch k[m].

In a similar fashion the CmC is formed, using Equation (2), for dual-frequency GNSS users in accordance with Equation (4) at every time epoch k, (for each space vehicle (SV)).

$$\begin{matrix}{CmC}_{biased , k}^{*} = {ρ}_{k}^{*} - {ϕ}_{k}^{*} \\ = - {N}_{ϕ , k} + {M}_{ρ , k} - {M}_{ϕ , k} + {ɛ}_{ρ , k} - {ɛ}_{ϕ , k}\end{matrix} \qquad ( 4 )$$

where:
CmC*_{biased}: iono-free biased Code minus Carrier residual at time epoch k [m]
N_{φ,k}: iono-free carrier phase ambiguity related bias component [m]
M_{ρ,k}: iono-free code phase multipath [m]
M_{φ,k}: iono-free carrier phase multipath [m]
ε_{ρ,k}: other iono-free code phase error terms [m]
ε_{φ,k}: other iono-free carrier phase error terms [m]

Equations (3) and (4) contain a carrier phase integer ambiguity, multipath, and receiver noise error terms associated with the code and carrier measurements. Typically, the CmC signal has been used to assess error variations in a post-processing fashion, where the mean value is subtracted from the data segment of interest.

The reduction of multipath has become an essential part of any high performance ground-based system architecture using GPS. A combination of a hardware approach in terms of antenna/radio frequency (RF) and receiver have been pursued to limit multipath; these include various system/antenna approaches documented by P. El´ osegui, J. L. Davis, R. T. Jalkehag, J. M. Johansson, A. E. Niell, and 1. I. Shapiro, “Geodesy using the Global Positioning System: The effects of signal scattering on estimates of site position”, Journal of Geophys. Res., 100(B6), pp. 9921-9934, 1995; Ray, J. K., “Use of Multiple Antennas to Mitigate Carrier Phase Multipath in Reference Stations”, in 1999 Proc. Institute of Navigation GPS Conf., Nashville, Sep. 14-17, 1999, pp. 269-279; B. Thornberg, D. S. Thornberg, M. F. DiBenedetto, M. S. Braasch, F. van Graas, and C. Bartone, “LAAS Integrated Multipath Limiting Antenna,” NAVIGATION Journal of The Institute of Navigation, vol. 51, No. 2, Summer 2003, pp. 117-130; A. Brown, “Multipath Rejection through Spatial Processing,” in 2000 Proc. Institute of Navigation CPS Conf, Salt Lake City, Utah, Sep. 19-22, 2000, pp. 2330-2337; W. Kunysz, “A Novel GPS Survey Antenna,” in 2000 Proc. Institute of Navigation National Technical Meeting, Anaheim, Calif., Jan. 26-28, 2000, pp. 698-705; and J. Dickman, C. Bartone, Y. Zhang, and B. Thornburg, “Characterization and Performance of a Prototype Wideband Airport Pseudolite Multipath Limiting Antenna for the Local Area Augmentation System”, in 2003 Proc. Institute of Navigation National Technical Meeting, Anaheim, Calif., Jan. 22-24, 2003, pp. 783-793. Additionally various software approaches are pursued to limit the multipath; these include approaches documented by K. W. Shallberg, P. Shloss, E. Altshuler, and L. Tahmanzyan, “WAAS Measurement Processing, Reducing the Effects of Multipath,” in 2001 Proc. Institute of Navigation GPS Conf., Salt Lake City, Utah, Sep. 11-14, 2001. pp. 2334-2340; L. R. Weill, “High-Performance Multipath Mitigation Using the Synergy of Composite GPS Signals”, in 2003 Proc. Institute of Navigation GPS Conf., Portland, Oreg., Sep. 9-12, 2003, pp. 829-840; Y. Zhang and C. Bartone “Real-time Multipath Mitigation with WaveSmooth™ Technique using Wavelets”, in 2004 Proc. ION GNSS Conf., Long Beach, Calif., Sep. 21-24, 2004, pp. 1181-1194; Y. Zhang and C. Bartone “Improvement of High Accuracy DGPS Positioning with Real-time WaveSmooth™ Multipath Mitigation Technique”, in 2005 Proc. IEEE Aerospace Conference, Big Sky, Mont., Mar. 5-12, 2005; and AJ. Van Dierendonck, P. Fenton, and T. Ford, “Theory And Performance of Narrow Correlator Spacing in a GPS Receiver” NAVIGATION Journal of The Institute of Navigation, vol. 39, No. 3, Fall 1992, pp. 265-284. These software approach can be classified into time domain processing and frequency domain processing. One of the classical time domain processing methods is carrier smoothed code (CsC), which is for example used in the development of the Local Area Augmentation System (LAAS); details of this technique can be found in RTCA Minimum Aviation System Performance Standards for the Local Area Augmentation System (LAAS), DO-253A, RTCA Inc., 1998, pp. 40-41, http://www.rtca.org. In order to limit bias accumulation (mainly, ionosphere divergence), a limitation of a 100s smoothing time constant is used where ionosphere divergence is estimated to occur at a typical rate of 0.018 m/s. This typical rate is documented for the LAAS in RTCA Minimum Operational Performance Standards for GPS Local Area Augmentation System Airborne Equipment, DO-245, RTCA Inc., 2001, pp. 30, http://www.rtca.org. Although the CsC is effective to reduce receiver noise, CsC can only mitigate very high frequency multipath error (>0.1 Hz) due to the 100s smoothing time constant constraint. According to the multipath model analysis, the multipath error fading frequency of a typical static ground-based reference station is typically less than 0.01 Hz as documented in J. Dickman, C. Bartone, Y. Zhang, and B. Thornburg, “Characterization and Performance of a Prototype Wideband Airport Pseudolite Multipath Limiting Antenna for the Local Area Augmentation System”, in 2003 Proc. Institute of Navigation National Technical Meeting, Anaheim, Calif., Jan. 22-24, 2003, pp. 783-793. Therefore CsC has limited capability in mitigating the majority of the multipath error, for ground-based, static or low dynamic applications.

A recent time domain processing technique is the code noise and multipath (CNMP) algorithm which is documented in K. W. Shallberg, P. Shloss, E. Altshuler, and L. Tahmanzyan, “WAAS Measurement Processing, Reducing the Effects of Multipath,” in 2001 Proc. Institute of Navigation GPS Conf, Salt Lake City, Utah, Sep. 11-14, 2001. pp. 2334-2340. This technique has been successfully demonstrated for code measurements and is being implemented in the Wide Area Augmentation System (WAAS). The cold start initial multipath bias takes time to average out, which is estimated to be about 30 minutes. The CNMP algorithm utilizes dual-frequency code and carrier phase measurements to form a multipath corrected code measurement; a CNMP ionosphere free (iono-free) measurement can be formed based on the CNMP multipath corrected code measurements. However, the CNMP iono-free code measurement (with the carrier phase ambiguity bias included), turns out to be essentially the same as the conventional iono-free carrier phase measurement, as described in Zhang. Y., Bartone, C. G., “Multipath Mitigation in the Frequency Domain,” Proceedings of IEEE Position Location And Navigation Symposium 2004, Sep. 9-12, 2004, Monterey, Calif., ISBN 0-7803-8417-2, © 2004 IEEE, pg. 486-495. For high accuracy differential GPS (DGPS) ambiguity resolution (especially for long baseline), the use of both multipath mitigated code measurements and carrier phase measurements are preferred to enhance the user solution, where code and carrier phase measurements are independent. This increased performance by using both the code and carrier phase measurements is documented in Y. Zhang and C. Bartone “Improvement of High Accuracy DGPS Positioning with Real-time WaveSmooth™ Multipath Mitigation Technique”, in 2005 Proc. IEEE Aerospace Conference, Big Sky, Mont., Mar. 5-12, 2005. Since the CNMP multipath mitigated code measurement is essentially the same as the carrier phase measurement, the CNMP algorithm is of limited value in this type of applications.

The major error components of GPS observables include clock bias, orbit error, troposphere, ionosphere, multipath, receiver noise, in the order from low to high frequency. Of primary concern are the error components whose frequency spectrum may overlap with the multipath error frequency spectrum, i.e. ionosphere error (relatively low frequency) and receiver noise (relatively high frequency). The frequency spectrum range is studied for typical ionosphere error and multipath error.

The ionosphere error typically has a low frequency spectrum than the multipath error. For a single-frequency user, the ionosphere error prediction depend upon the broadcast parameters user position, local time, and SV elevation and azimuth angles. Additional detail on the GPS broadcast ionosphere model can be found in J. A. Klobuchar, Ionospheric Effect on GPS, in Global positioning System. Theory and Applications, Vol. 1, B. Parkinson, J. Spilker, P. Axeraid and P. Enge, American Institute of Aeronautics, 1996, pp. 485-515, and GPS Interface Control Document (ICD), ICD-GPS-200C, Navstar GPS Space Segment/Navigation User Interface, U.S. Air Force, 10 Oct. 1993, pp. 114-116 and 125-128, which can be used to investigate the typical rate the of the ionosphere error. The ionosphere error is commonly modeled as a time series is a typical half cosine wave. The Fast Fourier Transform (FFT) frequency spectrum of ionosphere errors has a maximum values at typical 5.8e-6 Hz and varies within the range from about 0 to 1.2e-4 Hz, for a particular snapshot of the predicted error.

For the multipath frequency analysis, a typical ground-based GPS application was considered. It should be noted that the mobile user tends to have a higher frequency multipath error, which is less likely to overlap with the ionosphere error frequency spectrum. The multipath model was used in J. Dickman, C. Bartone, Y. Zhang, and B. Thornburg, “Characterization and Performance of a Prototype Wideband Airport Pseudolite Multipath Limiting Antenna for the Local Area Augmentation System”, in 2003 Proc. Institute of Navigation National Technical Meeting, Anaheim, Calif., Jan. 22-24, 2003, pp. 783-793, and used in combination with Fourier analysis, to capture the multipath frequency spectrum range. With the assumption of a single ground reflection, for a sampling frequency of 1 Hz, and antenna height of 8.58 ft, the frequency spectral component of the multipath error ranges from about 0.003 to 0.02 Hz. In summary, a typical ionosphere error frequency is less than 1.2e-4 Hz, whereas a typical ground multipath error frequency is higher than 0.003 Hz. The ionosphere and multipath error are characterized in different frequency ranges. This fact indicates that most of the multipath error can be isolated from the ionosphere error from frequency perspective and thus can be mitigated through the frequency domain processing; to limit the scope of this paper, dual-frequency GPS receivers are used such that the main ionosphere error component is removed in the iono-free measurement formulation.

### BRIEF SUMMARY OF THE INVENTION

In this patent, a new technique FDsmooth™ is introduced for multipath error mitigation in GNSS architectures. The FDsmooth™ technique included in this patent is applicable to two main classes of GNSS architectures; 1) single-frequency error mitigation, and 2) multi-frequency error mitigation. For single-frequency GNSS architectures multipath error mitigation comes after the ionosphere error has been removed by a model or other means. For multi-frequency GNSS architectures (e.g., dual-frequency GPS) multipath error mitigation can occur by operating on the ionosphere-free measurements; GPS is used to illustrate the FDsmooth™ technique.

### BRIEF DESCRIPTION OF THE SEVERAL VIEWS OF THE DRAWING

Not Applicable.

### DETAILED DESCRIPTION OF THE INVENTION

In this patent, the FDsmooth™ technique is useful for multipath error mitigation in various GNSS architectures. To illustrate the details of the FDsmooth™ technique dual-frequency (i.e., ionosphere free) GPS measurements will be used as a test case to illustrate the FDsmooth™ technique.

Step 1: Multipath Spectrum Estimation. The multipath frequency spectrum can be estimated in at least two ways. When the multipath fading frequency can be well predicted, such as a controlled ground-based reference station location, it can be predicted from a multipath model, which is a function of the antenna height, SV elevation angle, reflection coefficient, code correlator spacing, etc. When the multipath fading frequency cannot be well predicted with a model, the multipath frequency estimation can be via spectral estimation of CmC residual; A demonstration of this spectral estimation can be found in J. Dickman, C. Bartone, Y. Zhang, and B. Thornburg, “Characterization and Performance of a Prototype Wideband Airport Pseudolite Multipath Limiting Antenna for the Local Area Augmentation System”, in 2003 Proc. Institute of Navigation National Technical Meeting, Anaheim, Calif., Jan. 22-24, 2003, pp. 783-793. For illustration purpose, with no lost in generality, a ground-based reference station multipath model is used here to illustrate the concept. The multipath model used to estimate the code multipath error m_{ρ}. A Fourier transform is applied to transfer the code multipath time series into frequency domain as in Equation (5).

$$X ( f ) = {\sum }_{t = k - τ + 1}^{k} {m}_{ρ} ( t ) {ⅇ}^{\frac{- j2π ft}{τ}} \qquad ( 5 )$$

where
X: FFT spectrum of estimated code multipath error
f: frequency [Hz]
k: current epoch index [s]
t: time series index of the data block [s]
τ: block size of data points [s]
m_{ρ}: time series of estimated code multipath error [m].

The multipath frequency bandwidth is identified and noted as F₀. The F₀ includes all the frequency elements f₀ which satisfies the condition as in Equation (6). Three parameters are used: scaling factor β, the peak frequency spectrum (|X|ₘₐₓ) and mean frequency spectrum (|X|ₘₑₐₙ).
F₀=f₀, |X(ƒ₀)≧|X|ₘₑₐₙ+(|X|ₘₐₓ−|X|ₘₑₐₙ)/β (6)
where
F₀: multipath frequency bandwidth [Hz]
f₀: multipath frequency elements [Hz]
   |X|ₘₑₐₙ: mean value of the FFT spectrum magnitude
   |X|ₘₐₓ: maximum value of the FFT spectrum magnitude
β: scaling factor.

In the case of 1 Hz sampling frequency, the receiver noise frequency component spread over 1 Hz bandwidth (from −0.5 to 0.5 Hz), whereas the ionosphere and multipath error frequency component reside in a very narrow 0.04 Hz bandwidth (−0.02 to 0.02 Hz). Therefore, |X|ₘₑₐₙ is close to the noise spectrum value.

The center multipath frequency is selected where the peak spectrum occurs. A scaling factor β is utilized to control the targeted removal bandwidth. When scaling factor β is zero, the bandwidth is zero with no mitigation. As β goes to positive infinity, all the error components (e.g., multipath, ionosphere) are mitigated except the noise (the noise is removed afterward using CsC). The β value selection is a tradeoff between the mitigation effect and the overlapping frequency spectrum of other measurement components in Equation (2), e.g., higher order ionosphere term. The greater the β, the more multipath mitigation is achieved at the risk of more frequency overlapping with other error components. The value of β is suggested with the following considerations.
1) Single frequency or dual-frequency. In the case of dual-frequency GPS measurements, the major ionosphere errors can be removed by forming iono-free measurements [19]. Therefore, a more aggressive approach (e.g. β=45) can be pursued since no overlap between multipath and ionosphere error. In the case of single frequency GPS measurements, β could be selected based on the following factors.
2) Frequency spectrums overlap of multipath and ionosphere error component. The selection of β is based on the knowledge of the multipath fading frequency and how well it is be isolated from the ionosphere frequency spectrum. The multipath fading frequency can be retrieved from a multipath frequency spectrum estimation process through either the multipath model or performing spectral estimation on the real CmC data. When well isolated, a more aggressive approach (e.g. β=45) is preferred for maximum multipath mitigation. When the signal multipath fading frequency is very low (close to the ionosphere frequency spectrum) or higher order ionosphere error become dominant (i.e., begin to overlap with some multipath frequency spectrum), a narrow bandwidth (e.g. β=5) can be used for multipath removal. Again, the scope of this paper is limited to dual-frequency receivers, and the detailed application for single frequency users is beyond the scope of this paper, but could in investigated in further research.
3) Type of application. The β selection provides the flexibility for different types of applications. For cm level high accuracy ambiguity resolution positioning type of application, a more conservative approach (e.g. β=5) is preferred, with minimal bias introduction; for dm-m level DGPS or precise point positioning application, a more aggressive approach (e.g. β=45) is considered to attain more multipath mitigation with reasonable bias. (Bias performance has been discussed in the previous section, but is a consideration in β selection.)

Step 2: Multipath Mitigation. The CmC formed in Equation (4) has a bias term (carrier integer ambiguity and initial multipath bias errors), which is a nuisance parameter and desired for removed in order to get a closer look at any time-varying multipath that might be present. The bias term is calculated as (7) in the real-time processing, which is the mean of the CmC from epoch k−τ+1 to epoch k. For a “small” smoothing block size τ, (i.e. less than a multipath cycle) the bias estimate will be less accurate. For a “large” smoothing block size τ. (i.e., comparable to a multiple multipath cycle), the average bias term in (6) will represents more precisely the true constant bias. Here, the smoothing block size τ, will essentially be the block size of data operated upon.

$$\overline{{CmC}_{biased , k}} {\vert}_{τ} = \frac{{\sum }_{j = k - τ + 1}^{k} {CmC}_{biased , j}}{τ} \qquad ( 7 )$$

At any given time epoch, k, the bias will be fixed as in Equation (7) and removed as described in Equation (8); however, as time goes on, this bias may change, if it is caused by multipath and will be updated at every measurement epoch k. It should be noted that the longer block sizes have a better chance to envelope lower rate multipath (slowly changing bias terms).

The remaining unbiased CmC residual can be expressed as Equation (8).

$$\begin{matrix}{CmC}_{unbiased} ( k ) = {CmC}_{biased} ( k ) - \overline{{CMC}_{biased , k}} {\vert}_{τ} \\ = {M}_{ρ} ( k ) - {M}_{ϕ} ( k ) + {ɛ}_{ρ} ( k ) - {ɛ}_{ϕ} ( k ) + {ɛ}_{u} ( k )\end{matrix} \qquad ( 8 )$$

As shown in Equation (8), an additional error term “epsilon with subscript u” is introduced in forming the unbiased CmC residual; this term represents an additional error component that may be introduced in the unbiasing procedure. This term will diminish when a large τ is applied or a longer previous data segment is available for CmC bias estimate.

The unbiased CmC residual was often too noisy to identify the highest anticipated multipath fading frequency of 0.005 Hz (for a typical ground-based application), so the unbiased CmC residual was smoothed by implementing a recursive filter as shown in Equation (9).

$${CmC}_{sm , unbiased} ( k ) = \frac{1}{L} {CmC}_{unbiased} ( k ) + \frac{L - 1}{L} {CmC}_{sm , unbiased} ( k - 1 ) \qquad ( 9 )$$

where
L: smoothing time constant [s]
sm: smoothed data

This smoothing operation doesn't significantly affect the multipath as long as the smoothing time constant, τ, is shorter than the highest rate multipath as described in J. Dickman, C. Bartone, Y. Zhang, and B. Thornburg, “Characterization and Performance of a Prototype Wideband Airport Pseudolite Multipath Limiting Antenna for the Local Area Augmentation System”, in 2003 Proc. Institute of Navigation National Technical Meeting, Anaheim, Calif., Jan. 22-24, 2003, pp. 783-793. In this case, the smoothing time constant was 30 seconds, which was only a fraction of the shortest anticipated multipath fading period of 200 second. Thus, a significant amount of the receiver noise was removed in the CmC operation without removing the multipath which was to be quantified.

The remaining residual expressed in Equation (9) exposes any multipath that was present in the measurement. This CmC residual was then transferred from the time domain into the frequency domain, and then compared to a frequency estimation of the multipath error in order to mitigate the multipath frequency component.

The smoothed unbiased CmC residual was formed as in Equation (9). This was transferred into the frequency domain as in Equation (10).

$${Y}_{sm} ( f ) = {\sum }_{t = k - τ + 1}^{k} {CmC}_{sm , unbiased} ( t ) {ⅇ}^{\frac{- j2π ft}{τ}} \qquad ( 10 )$$

where
Yₛₘ: FFT spectrum of smoothed CmC residual
CmC_{sm,unbiased}: time series of smoothed CmC residual [m].

Given the knowledge of the multipath frequency bandwidth from Step 1, a windowing function was applied to the FFT spectrum to filter out the multipath frequency component, as in Equation (11).
Y_{sm,mitigated}(ƒ)=Yₛₘ(ƒ)H(F₀) (11)
where
Y_{sm,mitigated}: the multipath mitigated CmC FFT spectrum.
H(F₀): windowing function

The windowing function H(F₀) is a transfer function of a casual filter (e.g. Chebyshev, Butterworth, etc.) with stopband F₀. Note that the non-casual filter (e.g. ideal filter) is not applicable for real-time signal processing as described in E. W. Kamen, and B. S. Heck, Fundamentals of Signals and Systems Using Matlab, Prentice Hall, 2000, pp. 37. In comparison with a Butterworth filter, the Chebyshev achieves sharper transition between the stopband and passband. Since sharper transition is preferred in isolating different error frequency components (e.g. multipath and ionosphere), Chebyshev filter was used in this paper.

An inverse Fourier transform was applied to Y_{sm,mitigated} as in Equation (11) to form the multipath mitigated CmC as Equation (12).

$${CmC}_{sm , mitigated} ( k - τ + 1 , … , k ) = {\sum }_{f = 0}^{τ - 1} {Y}_{sm , mitigated} ( f ) {ⅇ}^{\frac{j2π ft}{τ}} \qquad ( 12 )$$

where
CmC_{sm,mitigated}: the multipath mitigated CmC [m].

Step 3: Multipath Correction. The code multipath correction is formed using Equation (9) and (12), at every current time epoch k as in Equation (13).
\hat{m}_{ρ}(k)=CmC_{sm,unbiased}(k)−C_{sm,mitigated}(k) (13)
where
\hat{m}_{ρ}: the code multipath correction [m].

The correction formed in Equation (13) is subtracted from the code measurement at every measurement epoch k to mitigate the multipath error as in Equation (14).
ρ*_{mitigated} (k)=ρ*(k)−\hat{m}_{ρ}(k) (14)
where
ρ*_{mitigated}: multipath mitigated code measurement [m].

In terms of filtering, the proposed technique can be categorized as an adaptive digital band-reject filter using a windowing FFT. Note that this technique is targeted to remove the multipath error within a certain fading frequency band, which leaves the low frequency component (such as ionosphere component in single frequency case) and the DC component (such as nonzero mean bias) unaffected. Based on the selection of block size and the multipath frequency bandwidth, certain AC components are removed but the DC component is largely unaffected at each time epoch k. As time proceeds, if the DC multipath bias term changes, the rate of this change, as characterized by the multipath spectral estimation process (i.e., model or spectral estimation on the CmC data), and will be targeted for removed in the frequency domain processing.

1. FDsmooth™ is a group of techniques that utilizes frequency domain aided method and operate on the Code minus Carrier (CmC) signal to mitigate inherent GNSS measurement errors in a real-time fashion to improve the performance of these GNSS.

2. A method according to claim 1 wherein said “frequency domain aided method” refer to all the GNSS error mitigation methods aided by frequency domain techniques in an optimum state of art to mitigate inherent GNSS measurement error.

3. A method according to claim 1 wherein said “group of techniques that” and “operate on the Code minus Carrier (CmC) signal” and “real-time fashion” covers removal of the bias in the CmC signal in real-time to enable enhanced performance of the GNSS.

4. A method according to claim 1 wherein said “inherent measurement errors” covers all the possible error components inherent in a GNSS including receiver noise, multipath, atmospheric error, environmental error, ionospheric delay, temperature error, spatial error, temporal error, etc.

5. A method according to claim 1 wherein said “performance” is in terms of complexity, cost real-time, position, velocity, time, accuracy, reliability, integrity, availability and continuity, etc.

6. A method according to claim 1 wherein said “improved performance” is obtained whereby the FDsmooth™ technique can be implemented in real-time for GNSS architectures.
